(19) United States
(12) Patent Application Publication
(10) Pub. No.: US 2013/0305385 A1
(43) Pub. Date: Nov. 14, 2013

(54) STREAMING AUDIO PLAYBACK SERVICE AND METHODOLOGY

(71) Applicant: CLOUD COVER MUSIC, Santa Monica, CA (US)

(72) Inventors: Martijn Korteweg, San Gabriel, CA (US); James Birch, Santa Monica (NL); Diana Burnell, Los Angeles, CA (US)

(73) Assignee: Cloud Cover Music, Santa Monica, CA (US)

(21) Appl. No.: 13/889,310

(22) Filed: May 7, 2013

Related U.S. Application Data
(60) Provisional application No. 61/644,545, filed on May 9, 2012.
(60) Provisional application No. 61/644,557, filed on May 9, 2012.
(60) Provisional application No. 61/644,581, filed on May 9, 2012.
(60) Provisional application No. 61/644,608, filed on May 9, 2012.
(60) Provisional application No. 61/644,637, filed on May 9, 2012.
(60) Provisional application No. 61/644,665, filed on May 9, 2012.
(60) Provisional application No. 61/644,682, filed on May 9, 2012.

(51) Int. Cl. G06F 21/10

(52) U.S. Cl. CPC G06F 21/10
USPC 726/27

(57) ABSTRACT

A service for streaming digital audio files to subscribing consumers is provided in a manner compliant with all applicable licenses. A method of using such service may include downloading licensed audio files onto a server configured to be managed automatically to ensure compliance, employing a playlist algorithm associated with the server that is configured to monitor and record certain attributes about the digital audio files, including the performing rights organization, the composer of the audio files, and/or the identify of the copyright owner of the audio file, and tracking the frequency of regeneration of the audio files on the server. An algorithm may be employed that constrains the streaming of the audio files so that consumers may influence the music that is streamed to them pursuant to consumer subscriptions, but limits the direct control over the specific audio files streamed to the subscribing consumers.

### RELATED APPLICATIONS

This application claims priority to provisional patent application U.S. Ser. Nos. 61/644,545, 61/644,557, 61/644,581, 61/644,608, 61/644,637, 61/644,665, and 61/644,682, all filed on May 9, 2012, the entire contents of which is herein incorporated by reference.

### BACKGROUND

### Field of Embodiments of the Invention

The embodiments herein relate generally to methods of providing streaming audio service to customers that permits customer influence over the song selection but restricts direct selection by the customers, thereby maintaining strict compliance with the licenses under which the songs are permissibly downloaded by the providing service. Content delivery network services exist today that involve one or more of several available formats in permitting customers to play for public performance songs within an environment controlled by the customers. Such customers include retailers, shopping centers, and the like. Although some services exist that do not comply with applicable copyright laws, the embodiments of the present invention focus on methods of providing music to customers for public performance that maintain adherence to copyright laws and restrain the exchange of music so as to remain in compliance with applicable licenses.

The exchange of music between music providers and customers may occur through the actual transfer of the music file or copies of the music file from provider to customers, where the customers may download the files to whatever server the customer chooses to become the source of music playback for public and/or personal performance. In that regard, many of those exchanges permit the customer to directly select not only the genre of music, but the specific artists, albums and songs, maximizing the customization of playback by the customer to the public. In some cases, an exchange may occur where the customer may be permitted to download the music, but the specific selection may be limited by the election of one or more genres, rather than the specific artists, albums and songs.

Other formats for exchange do not involve actual file sharing between provider and customer, but rather involve the streaming of music, where the customer is not permitted to download the files themselves, but receives the files in digital format in streaming fashion for playback. In such situations, no “copy” is made by the customer—at least not permissibly. Of course many individuals may surreptitiously by-pass the constraints placed on music exchange, but that is not the subject of the present invention.

The copyright holders of the thousands of songs available for license, in combination with the organizations that manage the distribution of music on behalf of those copyright holders, set forth strict constraints on the type and frequency of playback through licenses that require monitoring and reporting obligations upon those upon whom licenses are granted. Embodiments of the present invention serve to facilitate the exchange of music employing algorithms that maximize the influence and enjoyment of the customer while maintaining compliance with the obligations of the licenses, including employing sufficient monitoring and reporting aspects that ensure license compliance.

### Technical Background

A content delivery network (CDN) is a means of rapidly supplying content to users of a web site. The web site operators place content, such as mp3 files, on a CDN “origin server” and the CDN automatically copies the content to many (generally thousands) of other servers (edge nodes) which are usually geographically distributed. When a user requests a piece of content from an on-line site (such as www.example.com/file1.mp3), they are automatically directed to an edge node geographically close to them, which delivers them the content. The content requests are distributed among many servers so that they do not overload a single server, and because it permits the system to more easily be enlarged. It also ensures that requests are fulfilled rapidly (by serving the user content from a nearby node, which is generally a high speed content service system). Many commercial CDN's exist today, such as those used by Akamai™ or Limelight™.

Files on CDN edge nodes often have expiry times, after which the file is removed. Expiry times and automatic purging exist because edge nodes only have a finite amount of available space and because sometimes when a piece of content changes frequently fast expiry times are desired. When dealing with a large library of media, the entirety of which is not accessed on a regular basis, it is a given that origin pulls will be performed regularly. If a piece of content is set to expire after an hour, then it may be removed from the edge nodes once it has existed on the edge node for an hour. Subsequent requests for that file will trigger an “origin pull” in which the origin server must redistribute the content to its edge nodes, and it will again live for the specified period of time. CDN's often automatically purge files from edge nodes when they aren't being accessed heavily, regardless of the expiry time.

As used herein, a playlist is a random or structured list of audio files. The customers, pursuant to embodiments of the present invention and other services that exist today, subscribe to and receive playlists according to their influence of direct selection, depending upon the service to which the customer subscribes. A mashup playlist is a playlist derived from one or more other existing playlists, and may sometimes be referred to as child playlists.

File permissions either grant or deny public access to specific files and folders for a single user, a group of users, or every user. Many web servers and CDN's support the ability to secure files via file permissions. A web server is any software system capable of transmitting files to users over a network, such as the Internet.

Many web servers and CDN's support the ability to secure files via signed URLs. Signed URLs are file pointers that contain an encrypted string of characters, created using a private key known to the client and server. An example of an encrypted string is below. When unencrypted the plaintext (unencoded version) of the string may contain information about valid start dates/times, expiration dates/times, and/or IP addresses that are allowed to access the file: www.example.com/file1.mp3?encryptedString=1ks31d09ss1k23kekfd1d101). In this case let's assume the unencrypted plain text of the value of 1ks31d09ss1k23kekfd1d101 is “start:1-1-2012, end:2-1-2012, ip:123.456.78.9, file: file1.mp3”).

Embodiments of the invention below are particularly relevant to progressive download audio players. An audio player is a program capable of playing back audio files. The player may play single files or multiple files organized into an ordered or random playlist. A permalink is a permanent link that a user can follow to get directly to the audio player, preloaded with a specific song or playlist. A permalink generally does not expire without some manual user intervention. A related concept is the “deep link,” a link that takes you into an application already loaded with a particular feature or piece of content. For purposes herein, the term permalink refers to both a traditional permalink and a deep link.

In some cases, a progressive download player downloads the entire song file (i.e., song1.mp3) from a standard web server (as opposed to the proprietary streaming servers such as Flash Media Server that are required by streaming players). The player begins playing the song once enough of the file is buffered. Progressive download players also generally do not encrypt the media files they serve to users. Consequently, because it is trivial for someone to discover where the file lives (i.e., http://www.example.com/media/song1.mp3) and because the file is served unencrypted by a standard web server, a user might share the links to the files with their friends or on a message board. It is easy to imagine a scenario in which a malicious party could even use links to many of the progressive download player's songs build their own unsanctioned media player using the open media library.

A private music library, such as a personal music library, is a collection of one or more audio files contained on a storage device such as a hard drive, RAM disk, compact disc, mobile device, or smart phones, such as an iPod® or iPhone® by Apple®, or similar products made by other manufacturers such as Android® or Samsung®, etc. Businesses cannot play private music collections (such as those purchased from iTunes and stored on an iPod) in a public setting unless they have obtained the proper public performance licenses. A licensed music database contains one or more audio files that have been licensed for (or can readily be licensed for) public performance. Along with each file the database stores information requisite to pay out public performance related royalties on the songs, such as the title, artist(s), featured performer(s), song length, album, genre, disc number, track number, publisher(s), label(s), release year, rights holder(s), and writer(s) of the song. The database also contains unique audio fingerprints for each audio file which have been generated using the fingerprinting device.

As used herein, a fingerprinting device is a piece of software or hardware capable of analyzing an audio file and creating a unique IDentification number for each audio file. Any suitable fingerprinting algorithm may be used by the fingerprinting device, provided it consistently produces the same ID for unique audio files. There are a number of existing audio fingerprinting algorithms, such as the open source Acoustid™ project.

Likewise, a workflow is a set of tasks executed in a certain order (sometimes with a set of conditional flows or loops). In the context of digital media usually it means a set of tasks that create or modify a media file. For instance, a workflow might take a master audio file and some metadata about the track and artist and after a series of steps (tasks) output a small mp3 file with the track and artist data embedded.

For purposes of context herein, user permissions is a software concept that restricts the number of actions any given user can take. For instance, in many operating systems “Administrator” users may perform any action, but users with “Standard” or “Regular” accounts may not install or uninstall new applications. In addition, many tracking (or “analytics”) systems exist in order to keep track of certain events. For instance the Google® Analytics web application automatically tracks all visitors to a web site and then displays reports related to the site's visitors (for instance, it might display the number of visitors to the site every day in a given month, or it might display the most common pages visited by all users).

### SUMMARY

In one embodiment of the invention, a media playback service is provided for streaming digital audio files to subscribing consumers in a manner compliant with any and all licenses applicable to audio files downloaded to a server pursuant to such licenses. In one example of a methodology, the service provider may download licensed audio files onto at least one server configured to be managed automatically to ensure compliance with the terms of the license(s) under which the audio files were downloaded, and employ a playlist algorithm associated with the server that is configured to monitor and record certain attributes about the digital audio files. The attributes selected may be based upon the terms of the license(s) that dictate the amount payable for the legal downloading and sharing of such audio content, including the performing rights organization, the composer of the audio files, and/or the identify of the copyright owner of the audio file. The methodology may further comprises tracking the frequency of regeneration of the audio files on the server, whereby the algorithm constrains the streaming of the audio files so that consumers may influence the music that is streamed to them pursuant to consumer subscriptions, but limits the direct control over the specific audio files streamed to the subscribing consumers.

In one embodiment, the media playback service further comprises categorizing downloaded audio files into categories defined by at least a genre reflective of the musical nature of the audio files within the category, and permitting the subscribing consumers to select one or more categories of music to be streamed in the form of digital audio files. In another embodiment, the may further comprised determining whether the subscribing consumer is performing the streaming audio files in a geographic region that impacts the constraints that must be maintained in place in order to remain in compliance with the license(s) under which the audio files were downloaded. It may also further comprise tracking the number of times certain audio files are streamed for performance by the subscribing consumers within a certain time period.

### BRIEF DESCRIPTION OF THE FIGURES

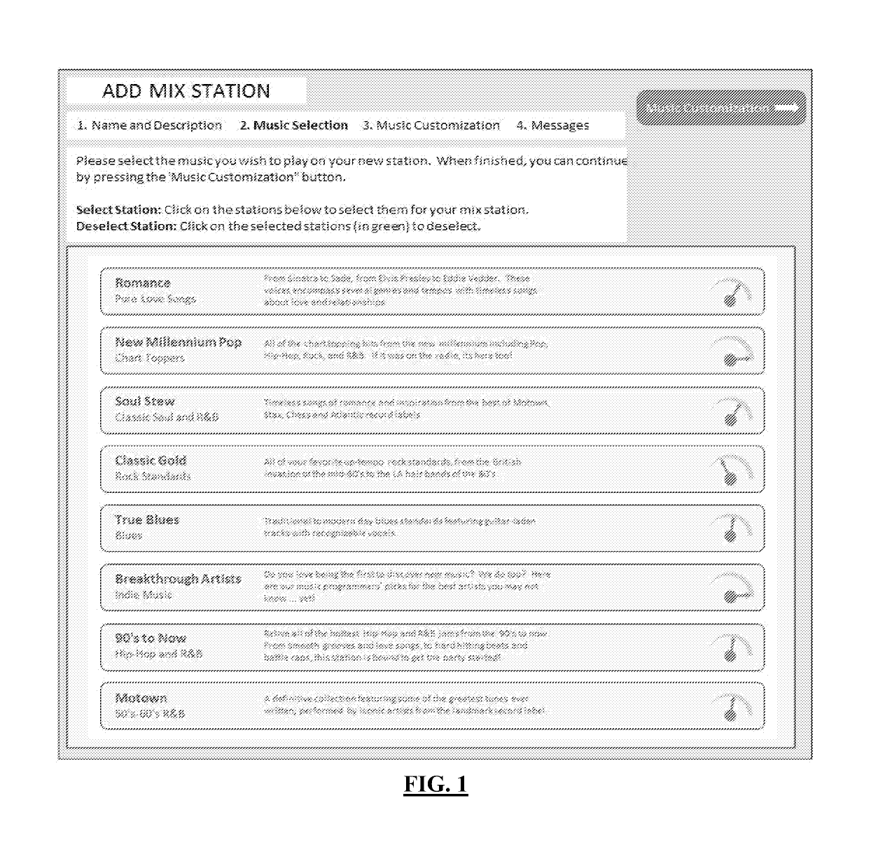

The detailed description of some embodiments of the invention will be made below with reference to the accompanying figures. In that regard, FIGS. 1 through 3 show schematic representations of graphic user interfaces applicable to one or more of the embodiments and methodologies described herein, where examples of certain types of functionality are provided.

### DETAILED DESCRIPTION OF CERTAIN EMBODIMENTS

A technique is provided for a media playback service (such as a streaming music player) to reduce the number of times a content delivery network must pull a piece of content and distribute it to its edge nodes, thereby saving time and money which result from this data transfer. One manner in which an origin-pull-minimization technique is performed is by having the service generate one or more playlists of media files; i.e., subsets of the entire database in which the subsets share one or more common parameters, such as music genre. In one embodiment, the service creates the playlists that end users may select in building a user playlist.

The playlist service responds to playlist requests by choosing random files from a subset of the entire content catalog. For instance, if the catalog of content contains one million files, a subset may include 1,000 files. Playlist requests will choose from among those 1,000 files during a given period of time, after which the subset may change to another 1,000 files. During any given period of time the number of origin pull requests will be reduced because users will be accessing most of the 1,000 files constantly so the files will not be purged from the edge servers.

For example, suppose a user selects a “Blues” playlist and clicks play on an audio player. The audio player could contact the playlist service and request a blues playlist, and the service might respond with a list of 100 random blues songs, chosen from the 1,000 file subset of songs. At this point the player would begin playing them. The next day if the user were to try to play some Blues again, the playlist service at this point might have shifted the subset to yet another 1,000 songs.

The playlist service may return a different playlist for each user or the same exact playlist to every user during a given period of time. The latter method minimizes origin pulls because the entire user base will be accessing the files so the files will be less likely to be purged from edge nodes. This way every hour (for example) each user will be served the same playlist, and the following hour they will all be served a different playlist.

If multiple playlists are needed (for instance for different genres of content) then the technique (of choosing subsets of the media library to pull from) is repeated for each sub-playlist, serving all users of the “Rock” genre the same playlist for requests issued within a given hour. In this case the number of unique media files accessed (and therefore the number of origin pulls) is still minimized, but across different playlists.

A file authentication scheme is described in order to comply with the public performance license when playing back audio files. The terms of a public performance license require that the audio files are streamed or distributed in a fashion that will not readily allow users to pirate or share the audio files. Thus this authentication scheme is particularly useful for a progressive download public performance license compliant audio player, since progressive download players are inherently unsecure. The scheme consists of a web server or content delivery network (CDN) and a music playback service.

One embodiment of the inventive music playback service is an application that serves audio file links to users in a manner that ensures against uncontrolled or unlimited sharing by the user with others. In other words, depending upon how the embodiment is set up, the user will not be able to share the audio file link with others so they can play the file, or if others are able to play the file then at the least their privilege to do so will not last indefinitely. This behavior can be accomplished by changing the file permissions on each file on a set schedule (i.e., by making a file publicly readable on the web server or CDN so that a user can play it, and then making in unreadable several minutes or hours later once the file should no longer be in use). The behavior can also be accomplished by providing signed URLs to users that contain encrypted instructions telling the web server or CDN to expire the link in several minutes or hours or to only allow the user at a certain IP address to access the file.

If the user pauses play back long enough for the signed URL or file permissions of the file to expire they will have to attempt to access the file again and rely on the music playback service to grant them permission. The music playback service might grant permission to that file again (by constructing a signed URL or making the file readable), it might choose to serve the user a different file, or it might just throw an error message. Either way, it is recommended that only an internal music playback service is allowed to grant access to files so that the security of the system is not easily defeated.

This technique prevents a user from sharing the links to the host audio files with their friends or posting them on a message board for the world to see. It works by either making certain files available and unavailable on the host server at different times (via file permissions) or by sending the users special links that expire after a given time or only work for a certain user's IP address. By preventing users from sharing the host files easily we make sure the player service is in not a haven for piracy, and reflects that the service is making efforts to protect the music tracks.

A method is provided to enable businesses to play back private music collections in public in compliance with license restrictions, or other business or legal restrictions. One embodiment of the method comprises a private music library, an audio fingerprinting device, a music playback service, and a licensed music database. The licensed music database contains fingerprints for each of its songs which were generated using the audio fingerprinting device. The music playback service uses the fingerprinting device to analyze some or all of the files in a user's music library and produce fingerprints for as many tracks as possible. It then compares this set of fingerprints against the fingerprints in the licensed music database. The songs from the user's private music library which have matching fingerprints in the licensed music database are considered publicly playable audio files (because they are known, licensable songs from the licensed music database that the user has copies of and wishes to play). The playback service is able to create playlists using these publicly playable audio files. The playback service may either be a program running locally on the user's computer (that holds their private music library) or a web application running on a remote server over the internet. The playback technique may either be playing back the locally stored file in the private music library, or streaming the file from the licensed music database over the internet. It is recommended that the selection of audio files available for playback is controlled by the music playback service so that only licensed audio files will be permitted to play and the user cannot choose to play an entire album, thus violating the public performance license.

One feature of embodiments of the present inventive method comprise the music playback service keeping a log of each audio file played back so that royalties can later be properly paid. If the playback service runs locally on the user's music library computer, then this service can report all files played back. If instead the playback service is a web application running remotely and streaming audio to the user, then this server may instead keep the record of all songs played back. Either way, the service may simply write to a file the date, time, and fingerprint of every song played. One may later use the fingerprints to pull in all data necessary for royalty payment (such as the publisher and composer of each song) from the licensed music database and may generate a report containing the date and time at which each song was played and all royalty payment information.

In one embodiment of the invention, a software service is provided to build playlists of audio files that can be executed in compliance with the public performance licensing restrictions that apply to many copyrighted songs. The service consists of a data store of songs and a software application. The data store contains one or more audio files which have been licensed for (or can readily be licensed for) public performance. Along with a link to each audio file, the data store holds information needed to pay out public performance related royalties on the songs, such as the title, artist(s), featured performer(s), song length, album, genre, disc number, track number, publisher(s), label(s), release year, rights holder(s), and writer(s) of the song.

The software application is a native program (residing on a user's computer or device), or web app. It accesses the data store and builds playlists of one or more audio files to be played back by a music player. The application can generate playlists containing audio files in a random or sorted order. The application accepts requests for playlists on a per user or per playlist type basis, returning (for instance) playlists either generated for a specific user or a specific genre of music, respectively. The application ensures that, within each playlist it generates and across all of the playlists it has generated for the same user, it will never return more than two songs per musical artist or album within a four hour window.

The application may enforce these business rules by storing (in a temporary or permanent data store such as a database, file, or cache hosted either on the user's device or on the web) the IDs of all of the songs or artists which have recently been selected in playlists served to the user and filtering them out of future playlists that are generated before serving them to the user. This may also be accomplished by organizing songs into groups that contain no more than two songs per musical artist or album and creating playlists from only one group for a user. For instance Group 1 may contain a selection of songs from all genres, and users 1 through 100 may be assigned to group 1 for the current week. All of their playlists will have songs from Group 1 and if their playlists are eight hours long and contain no duplicate tracks then it is guaranteed that their playlists will contain no more than two songs per musical artist or album every four hours. If some playlists are shared among multiple users then all of the above methods would apply, but the outputted playlist would be shared among all users.

In some embodiments of the present invention, an audio message workflow is described that allows users to create custom audio messages (for instance promotional messages intended to sell a product) to be inserted into music streams or playlists between or during tracks. The workflow consists of a custom audio message specification service, a delivery service, and a custom message data store.

The custom audio message specification service is a software process that allows a user to define one or more attributes about an audio message, such as a promotional message for a product (i.e., “Have your next birthday party at Joe's Pottery store”). These attributes include the text of the custom message, the gender of the performer of the message, the age of the performer of the message, the tempo or cadence in which the message is performed, the tone of the performer of the message, the volume of background music accompanying the message, and the tone of background music accompanying the message. Once the user submits this information (for instance through a form on a web page) the message attribute data is relayed to the custom audio message delivery service. The input form may also optionally accept payment for the custom message.

The custom audio message delivery service is an automated software process that takes custom message attributes (as collected by the custom audio message specification service described above) as inputs and outputs an audio message (such as an mp3 file of a promotional message performed to the user's specifications) to the custom message data store. The outputted custom message can later be retrieved from the custom message data store on demand and inserted into music playlists. In short the system is a piece of software which keeps track of multiple workflow jobs as they progress from initial creation (they are created by the custom audio message specification service), through a series of tasks either automatic or manual (tasks such as record message, insert background music, upload finished product, etc . . . which may be completed by a human or by software), until the job results in a completed custom audio message, or the job is canceled. This service consists of a data store where it keeps track of the state of each workflow job and any media associated with each job, and a user interface which may be a website that reveals the state of each workflow job and allows users to enter data or alter existing jobs (for instance cancel them).

The custom audio message delivery service may be as simple as a system that e-mails the message attributes to a single voice actor, who then performs and records the message to the desired specifications (using their computer's microphone and some recording software) and then uploads the finished file to the system, at which point it will be catalogued in the custom message data store. It may also be a system which routes custom messages to a known pool of voice actors (according to their age, gender, performance ability and schedule availability) to be recorded. For instance all requests for messages to be recorded by a female aged 20-30 may be routed to Suzanne (i.e., Suzanne will get an e-mail, or will perhaps see a notification when she logs into a specific web site), and requests for male performers aged 30-40 may go to Greg. It may also route custom messages to a system operator that manually coordinates performances and uploads the resulting messages back into the system. The system may also be fully automated and produce a custom message with no human intervention via the use of speech synthesis or by combining several pre-recorded messages. In any of the scenarios described above the background music may be inserted by an automatic or manual step in the delivery service. For instance if the custom audio message specification called for upbeat music at volume 6 the final step of the workflow may be for the system to automatically choose Upbeat.mp3 and add it as a track to the custom message at volume 6, or it could just send an e-mail to the system operator, who uses some audio editing software on her computer to make the change and then upload the completed file to the system.

The custom message data store holds links to custom messages that have been created (i.e., www.example.com/custommessage1.mp3), as well as information about the user that requested the custom message, and the attributes the user specified for the custom message (text, gender, age, tempo, cadence, performer tone, music volume, music tone). The data store may later be used to dynamically insert the custom messages into playlists or playback streams for the user that requested the custom message or a group of users. For instance, suppose a service exists to stream music and that it is playing music for the user with ID 17. After every fifth song the service contact the custom message data store and retrieve (at random) a custom message that has been associated with user 17. The service could play the retrieved custom message and then repeat the process, playing back songs and then retrieving and playing back a custom message.

In some embodiments, a software service is provided to build mashup playlists. The service may consist of a music data store, a playlist settings data store, a mashup playlist service, and a mashup playlist application. In one example, the music data store contains one or more audio files which have been licensed for (or can readily be licensed for) public performance. Along with each file the data store holds information needed to pay out public performance related royalties on the songs, such as the title, artist(s), featured performer(s), song length, album, genre, disc number, track number, publisher(s), label(s), release year, rights holder(s), and writer(s) of the song.

The playlist settings data store contains information about each child playlist and mashup playlist. The information stored for each child playlist includes genres, tempos, and moods of music tracks that are eligible for insertion into the child playlist. It also includes specific individual music tracks that are eligible for insertion into the child playlist. The information stored for each mashup playlist includes one or more child playlists along with time windows (of a 24 hour clock) in which each individual child playlist should be played. Time windows may be classified as active for one or more single days of the week or across every day of the week. A mashup may contain one or more time windows for each child playlist. A mashup may also have multiple child playlists whose time windows overlap. Child playlists of a mashup may be ordered such that one child playlist takes priority. The volume of child playlists may also be specified within the mashup playlist.

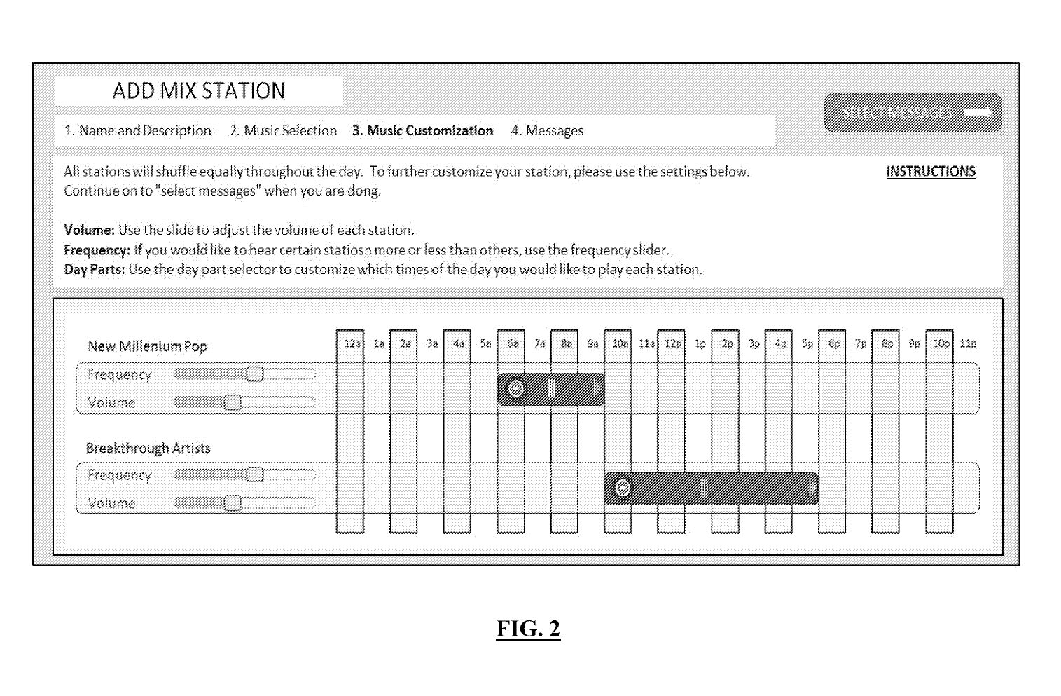

With reference to FIGS. 1 and 2, a mashup playlist service can be a software application that responds to requests for mashup playlists. It accesses the playlist settings data store to read the rules for the requested mashup playlist, it checks the current time of day, and then it fetches and returns a selection of audio tracks from the music data store in accordance with the mashup rules at the current time. In some embodiments, the mashup playlist application may be a graphical user interface to the playlist settings data store which allows users to view, create, modify, and delete mashup playlists and their settings.

In some embodiments of the invention, a service is provided to generate a playlist of music tracks with custom messages (for instance promotional messages intended to sell a product) inserted between or during songs. A custom message is a user submitted or specified audio clip. The service consists of a music data store, a custom message data store, a custom message settings data store, and a custom message insertion service. The custom message insertion service reads the custom message settings data store, the custom message data store, and the music data store and responds to requests for playlists by returning a combination of custom messages and music as specified by the rules in the custom message settings data store.

The music data store contains one or more audio files which have been licensed for (or can readily be licensed for) public performance. Along with each file the data store holds information needed to pay out public performance related royalties on the songs, such as the title, artist(s), featured performer(s), song length, album, genre, disc number, track number, publisher(s), label(s), release year, rights holder(s), and writer(s) of the song.

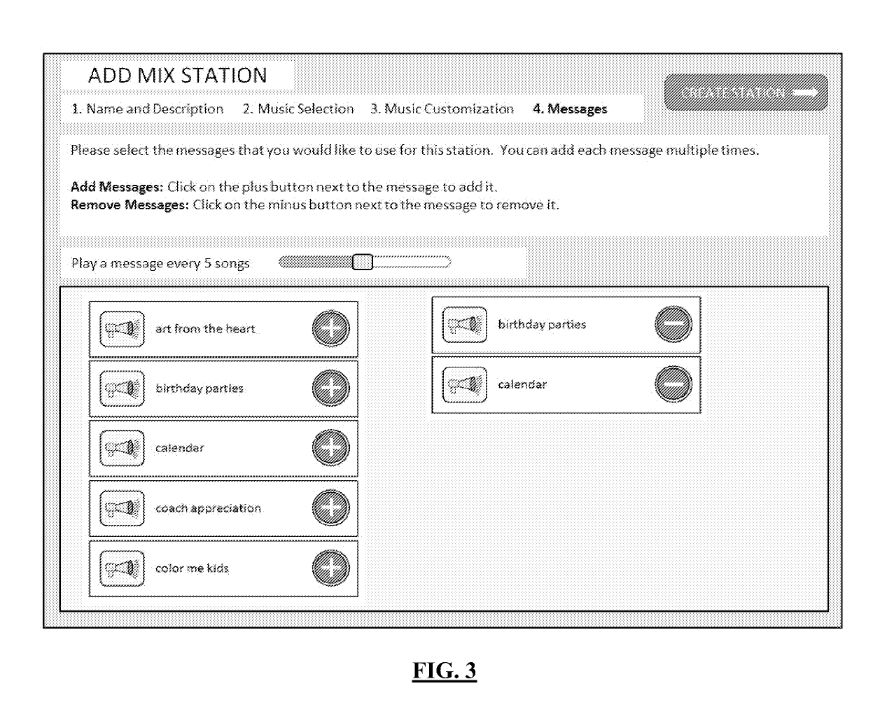

Referring to FIG. 3, one example of a custom message data store holds custom messages that have been created, as well as information about the user that requested the custom message, and the attributes the user specified for the custom message (text, gender, age, tempo, cadence, performer tone, music volume, music tone). The custom message settings data store holds information about when custom messages should be inserted into playlists. It holds a list which relates each custom message to a number of playlists, where each custom message may relate to multiple playlists and each playlist may contain multiple custom messages. For each custom message/playlist relationship the custom message settings data store specifies the frequency with which the custom message can be played back as it relates to musical tracks in the playlist and the frequency with which the custom message should be played back as it relates to other custom messages in the playlist. Additionally the custom message settings data store contains a setting for each playlist the assigns the overall volume of all messages with relation to all music in the playlist.

In some embodiments, an audio player is provided that may be accessed via a permalink so that it is preloaded with a playlist. The player obtains its playlist from a playlist service, a software application which generates lists of audio files. The playlists used by the playlist service may be predefined by the system (according to audio file metadata such as genre) or by users (who choose specific audio files). Playlists may also be a combination of one or more other existing playlists. Each playlist (including combination playlists) has a unique ID. User accounts may have a default playlist ID assigned to them. User accounts may also have a parent or umbrella account which consists of one or more user accounts, and these parent accounts may also have a default playlist ID.

The player application may be a native application or a web application. It takes a parameter which can be either a playlist ID, user ID, or parent account ID which instructs the player to load and playback the audio files in the specified playlist or the default playlist for the user or parent account. The player permalink is a link to the player application which contains the playlist and/or user and/or parent account ID parameter (e.g., www.example.com/player?playlistId=1234 or www.example.com/player?accountId=4321). When the permalink is requested by a web browser the player fetches the list of audio files by calling the playlist service and passing the ID.

The permalink may be an authenticated or be unauthenticated link. If the link is unauthenticated the permalink will take anyone to the playlist even if they are not a registered user of the system. If the link is authenticated it may require the user to login to the system before they are able to play music. If the user has recently logged in and has this state recorded somewhere on their system (such as a web browser cookie, cache, or database, or in a file on their computer or mobile device) the user may be able to bypass authentication using this token. Authentication may also take place via a permalink which contains an instructional hash signed by a private key known to the system and the user (for instance www.example.com/player?playlistId=1234&auth=1k2k1k1241tkg0f0s99ie24j, where the alpha-numeric characters 1k2k1k1241tkg0f0s99ie24j, when unencrypted, translates to a plaintext message such as (“allow user 4321 to play playlist 1234”).

In yet another embodiment, an audio player is provided that uses common controls to handle multiple audio content types, including songs and custom messages. A custom message, as alluded to above, is a user submitted or specified audio clip (for instance promotional messages intended to sell a product). The audio player's user interface may consist of a volume control, a play/pause button, and a next song button, as well as other appropriate or desired functional controls. The play/pause button changes appearance depending what upon the current state of the player. If the player is playing back a song the pause button is visible, if the player is paused the play button is visible. When a custom message is being played back the next song button may not be functional and may disappear or change appearance to indicate that it cannot be used.

The audio player is preferably configured to track every song and custom message played, for reporting purposes where licenses and applicable law requires. This may be accomplished by sending data about the song or custom message played to a tracking data store. The data sent to the data store may include a unique ID for the song or custom message played, the ID of the user playing the song or custom message, and the time of day the file began and completed playing. Information relating to user actions is also transmitted, for instance any time a user interacts with the player controls the time, user ID, current song or custom message, and the control manipulation action (such as click the pause button) is sent to the tracking data store.

In some embodiments, a users service with customizable permissions is provided for use with a public performance license compliant music player. The service is a software system containing information about one or more users and their abilities. The users service comprises information about user accounts and designates whether each user is a standard user or administrator. User accounts can be assigned one or more privileges, administrator accounts have all privileges.

The privileges include the ability to create, modify, assign privileges to, and delete user accounts, the ability to insert custom messages into playlists (for instance promotional messages intended to sell a product), alter the position and volume of the custom messages in playlists, control the overall volume of a player across all or several playlists, and to create custom mashup playlist stations which combine other existing playlists. Users may also be allowed or denied the ability to alter account subscription settings dealing with billing, location information (regarding a business location, or other location that will be playing music in public), and viewing music and custom message playback reports. Group level permissions may also be created and users may be assigned to one or more groups so that privileges may be granted or revoked en masse.

In one example embodiment, an audio player tracking system is described for use with businesses that wish to play licensed music. The system includes one or more data stores, an audio player, and an optional tracking beacon router and as a whole it enables a businesses to pay royalties for copyrighted music they have played in public.

The data store may be a permanent or temporary data storage method, for instance a database or file. The data contained within it consists of a list of songs along with the date and time the song was played, the business location in which the song was played publicly, and the title, artist(s), featured performer(s), song length, album, genre, disc number, track number, publisher(s), label(s), release year, rights holder(s), and writer(s) of the song. Any additional attributes that make it possible to pay out royalties on the public performance of the song should also be included in the data store. In addition to copyrighted songs, information about non-copyrighted songs and audio clips will be stored, for instance the date, time, and location at which an advertisement promoting a business was played and the details of the advertisement (such as an id and title of the advertisement).

The audio player component preferably comprises an application capable of transferring audio files from a networked or local storage location on a computer. The player has the ability to transmit tracking beacons which uniquely identify all audio files played. These beacons may contain information relating the time the audio file began and ended playback and any times in which its playback was paused. The audio player transmits these tracking beacons to a data store either directly or via a tracking beacon router. The tracking beacon router is an application which receives and queues tracking beacons and later shepherds the tracking information they contain into the data store. Its purpose is to ensure that the data store never becomes overloaded with requests to store tracking data.

In another example embodiment, a reporting system is provided for use with businesses that play licensed music. The system comprises a data store and a report generator and it enables businesses to pay royalties for copyrighted music they have played in public. The data store may be a permanent or temporary data storage method, for instance a database or file. The data contained within it may consist of a list of songs along with the date and time the song was played, the business location in which the song was played publicly, and the title, artist(s), featured performer(s), song length, album, genre, disc number, track number, publisher(s), label(s), release year, rights holder(s), and writer(s) of the song. Any additional attributes that make it possible to pay out royalties on the public performance of the song should also be included in the data store. In addition to copyrighted songs, information about non-copyrighted songs and audio clips will be stored, for instance the date, time, and location at which an advertisement promoting a business was played and the details of the advertisement (such as an id and title of the advertisement).

The report generator may be a software tool for analyzing and presenting the data in the data store. In particular it is capable of presenting a list of the audio tracks played for individual business locations or chains (consisting of more than one business with a common owner) over the course of a period of time (i.e., daily, weekly, monthly, yearly) a list of the audio tracks played by individual artists across all business locations, a list of all non copyrighted songs or messages (such as promotional advertisements) played in individual businesses or chains, and a list of the songs played which contains royalty payment specific information, such as the title, artist(s), featured performer(s), song length, album, genre, disc number, track number, publisher(s), label(s), release year, rights holder(s), and writer(s) of the song.

Additionally the system is able to generate daily, weekly, and monthly royalty reports that contains information specifically required for royalty handling by the, for example, Sound Exchange performance rights organization.

It is important to note that embodiments and methodologies of the inventions herein may use one or more of the several features described herein. Moreover, persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A media playback service for providing digital audio files in streaming mode to subscribing consumers in a manner compliant with any and all licenses applicable to audio files downloaded to a server pursuant to such licenses, the method comprising:
downloading licensed audio files onto at least one server configured to be managed automatically to ensure compliance with the terms of the license(s) under which the audio files were downloaded;
employing a playlist algorithm associated with the server that is configured to monitor and record certain attributes about the digital audio files, the attributes selected based upon the terms of the license(s) that dictate the amount payable for the legal downloading and sharing of such audio content, the attributes including the performing rights organization, the composer of the audio files, and/or the identify of the copyright owner of the audio file; and
tracking the frequency of regeneration of the audio files on the server;
whereby the algorithm constrains the streaming of the audio files so that consumers may influence the music that is streamed to them pursuant to consumer subscriptions, but limits the direct control over the specific audio files streamed to the subscribing consumers.

2. The media playback service of claim 1, further comprising categorizing downloaded audio files into categories defined by at least a genre reflective of the musical nature of the audio files within the category, and permitting the subscribing consumers to select one or more categories of music to be streamed in the form of digital audio files.

3. The media playback service of claim 1, further comprising determining whether the subscribing consumer is performing the streaming audio files in a geographic region that impacts the constraints that must be maintained in place in order to remain in compliance with the license(s) under which the audio files were downloaded.

4. The media playback service of claim 1, further comprising tracking the number of times certain audio files are streamed for performance by the subscribing consumers within a certain time period.
